(19) United States
(12) Patent Application Publication
(10) Pub. No.: US 2018/0367187 A1
(43) Pub. Date: Dec. 20, 2018

(54) RANGE INCREASE FOR MAGNETIC COMMUNICATIONS

(71) Applicant: QUALCOMM Incorporated, San Diego, CA (US)

(72) Inventor: Anthony MCFARTHING, Ely (GB)

(21) Appl. No.: 15/625,164

(22) Filed: Jun. 16, 2017

(51) Int. Cl. H04B 5/00; H04B 5/02; H04B 1/69

(52) U.S. Cl. CPC H04B 5/0075; H04B 1/69; H04B 5/02

(57) ABSTRACT

The disclosure relates to techniques to increase the range over which magnetic field induction can be used to communicate data between a transmitting antenna and a receiving antenna. In particular, a transceiver may comprise an antenna configured to transmit a signal via magnetic field induction, a transmit section having an amplifier, a capacitance, and a resistance arranged to form a parallel resonant circuit, and a processing unit configured to generate the signal transmitted via the antenna and to use a spreading code to modulate the signal to be transmitted via the antenna.

### TECHNICAL FIELD

The various aspects and embodiments described herein generally relate to magnetic communications, and more particularly, to using a suitable channel access method to increase the range and possible use cases for magnetic communications

### BACKGROUND

Part of a typical near-field communication (NFC) system is shown schematically at 10 in FIG. 1. In the NFC system 10 as shown in FIG. 1, an NFC reader 12 includes a transmitter section that has a voltage source power amplifier 14 with differential outputs connected to input terminals of an antenna 16. The NFC reader 12 further includes capacitances 18a, 18b connected in series between the outputs of the power amplifier 14 and the input terminals of the antenna 16. A further capacitance 20 is connected in parallel between the outputs of the power amplifier 14 and the antenna 16, while resistances 22a, 22b are connected in series between the capacitances 18a, 18b and the input terminals of the antenna 16. In general, those skilled in the art will appreciate that the capacitance 20 and the resistances 22a, 22b are usually parasitic rather than explicit components of the antenna 16. The capacitances 18a, 18b, 20 and the resistances 22a, 22b form, with the inductance of the antenna 16, a mainly series resonant circuit. The power amplifier 14, capacitances 18a, 18b, 20, and resistances 22a, 22b may be implemented as an integrated circuit (i.e., may be “on-chip” components), while the antenna 16 may be an off-chip component (i.e., external to the integrated circuit containing the power amplifier 14, capacitances 18a, 18b, 20, and resistances 22a, 22b).

Referring to FIG. 1, an NFC tag 24 may communicate with the NFC reader 12 via an antenna 26, with the other components of the NFC tag 24 including a capacitor 28 and a resistor 30 connected in parallel with the antenna 26. The resonant frequency of the resonant network formed from the capacitances 18a, 18b, 20, the resistances 22a, 22b, and the self-inductance of the antenna 16 is determined at least in part according to the value of the capacitances 18a, 18b, 20. For optimum transmission of data, the resonant frequency of the parallel resonant circuit should be equal to, or at least very close to, the frequency of the signal to be transmitted by the NFC reader 12.

As will be apparent to those skilled in the art, the NFC reader 12 as shown in FIG. 1 uses a series resonant antenna 16. This is required because only a series resonant antenna is able to power the external passive NFC tag 24. However, the use of the series resonant antenna 16 limits the magnetic field strength that can be achieved via the antenna 16 of the NFC reader 12, as the current through the antenna 16 that creates the magnetic field can never exceed the current output from the power amplifier 14. As a consequence, the limited magnetic field strength that can be produced using the design approach shown in FIG. 1 limits the magnetic communication range.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, a transceiver as described herein may comprise an antenna configured to transmit a signal via magnetic field induction, a transmit section comprising an amplifier configured to drive the antenna, a capacitance connected in parallel with the antenna, and a resistance connected in parallel with the capacitance and the antenna, such that the antenna, the capacitance, and the resistance form a parallel resonant circuit, wherein a value of the resistance is variable to permit adjustment of a loaded quality factor of the parallel resonant circuit. In addition, the transceiver may comprise a processing unit configured to generate the signal transmitted via the antenna and to use a spreading code to modulate the signal to be transmitted via the antenna.

According to various aspects, a method for magnetic communications as described herein may comprise generating, at a processing unit, a signal to be transmitted via magnetic field induction, wherein the processing unit is configured to use a spreading code to modulate the signal and transmitting the signal via an antenna configured to transmit the signal via the magnetic field induction, the antenna coupled to a transmit section comprising an amplifier configured to drive the antenna, a capacitance connected in parallel with the antenna, and a resistance connected in parallel with the capacitance and the antenna, such that the antenna, the capacitance, and the resistance form a parallel resonant circuit, wherein a value of the resistance is variable to permit adjustment of a loaded quality factor of the parallel resonant circuit.

According to various aspects, an apparatus as described herein may comprise means for generating a signal to be transmitted via magnetic field induction, means for modulating the signal using a spreading code, and means for transmitting the signal via the magnetic field induction, wherein a capacitance is connected in parallel with the means for transmitting and a resistance is connected in parallel with the capacitance and the means for transmitting, such that the means for transmitting, the capacitance, and the resistance form a parallel resonant circuit, wherein a value of the resistance is variable to permit adjustment of a loaded quality factor of the parallel resonant circuit.

According to various aspects, a computer-readable storage medium as described herein may store computer-executable instructions configured to cause a processing unit to generate a signal to be transmitted via magnetic field induction, use a spreading code to modulate the signal, and transmit the signal via an antenna configured to transmit the signal via the magnetic field induction, wherein a capacitance is connected in parallel with the antenna and a resistance is connected in parallel with the capacitance and the antenna, such that the antenna, the capacitance, and the resistance form a parallel resonant circuit, wherein a value of the resistance is variable to permit adjustment of a loaded quality factor of the parallel resonant circuit.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates a typical near-field communication (NFC) system including an NFC reader and an NFC tag, according to various aspects.

FIG. 2 illustrates an exemplary transceiver that can communicate data using magnetic field induction, according to various aspects.

FIG. 3 illustrates various components that may be present in a Near Ultra Low Energy Field (NULEF) transceiver, according to various aspects.

FIG. 4 illustrates an exemplary circuit that may implement one or more components in a NULEF transceiver, according to various aspects.

FIG. 5 illustrates an exemplary graph of antenna coupling versus distance for a magnetic transmitter and a magnetic receiver, according to various aspects.

FIG. 6 illustrates an exemplary processing device that may advantageously implement the various aspects described herein.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

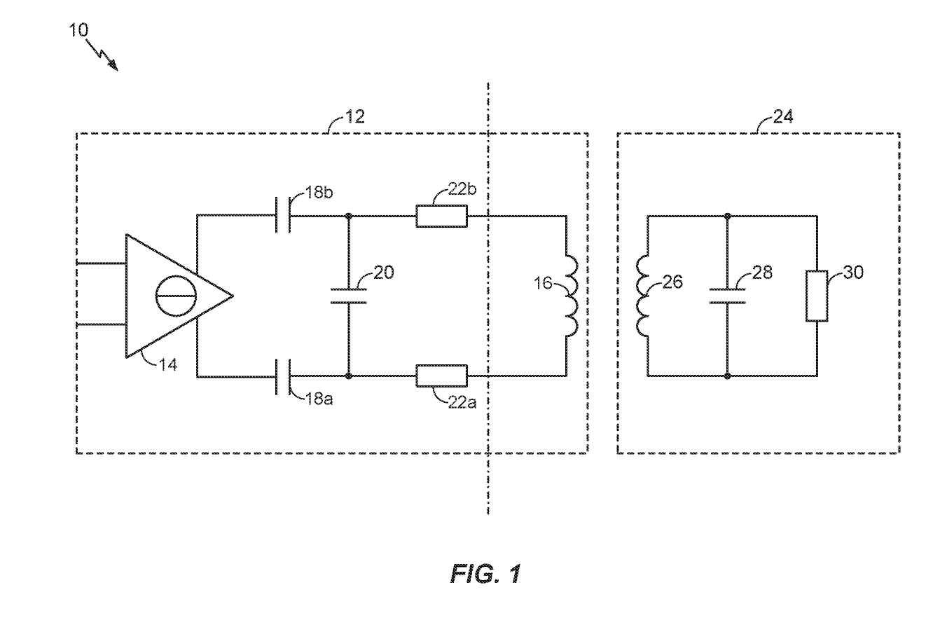

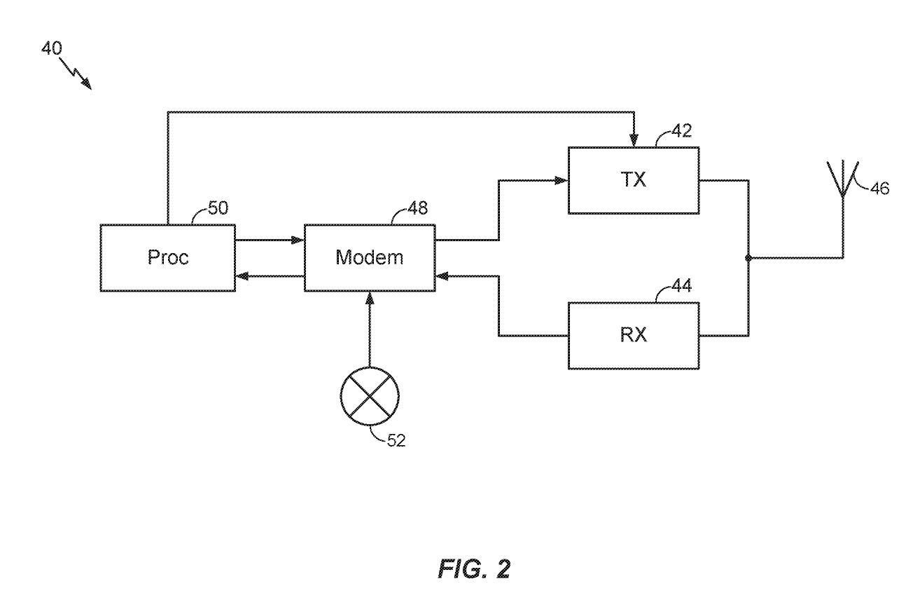

According to various aspects, FIG. 2 illustrates an exemplary transceiver 40 that can communicate data using magnetic field induction. In various embodiments, the transceiver 40 illustrated in FIG. 2 may be suitably used in a scheme referred to as Near Ultra Low Energy Field (NULEF) communications. More particularly, as will be described in further detail herein, the term NULEF generally refers to a magnetic communication system that has developed from an NFC environment, in that magnetic field induction is similarly used to communicate data between a NULEF transmitter and a NULEF receiver. However, in a NULEF magnetic communication system, the antenna used in the transmitter and the antenna used in the receiver are substantially symmetrical, whereby the performance of the transceiver 40 is not compromised when switching between transmit and receive modes, as would otherwise occur with the NFC system 10 shown in FIG. 1. Furthermore, whereas a possible communication range in the NFC system 10 as shown in FIG. 1 is limited to approximately 100 mm or less, a NULEF magnetic communication system may advantageously offer an increased communication range, up to approximately five (5) meters depending on antenna sizes.

NULEF magnetic communication systems generally enable communication between a NULEF transmitter and a NULEF receiver via a magnetic field that obeys an inverse cube law, in that the magnetic field has a strength that falls off as a cube of the distance between the transmitting antenna and the receiving antenna. In other words, for every increase in distance between the transmitting antenna and the receiving antenna by a factor of ten (10), the signal level produced at the receiving antenna would decrease approximately sixty decibels (60 dB), which is a relatively substantial change in attenuation versus distance. Among other advantages, magnetic communications are achieved via magnetic fields that can effectively penetrate many solid objects including the human body, materials commonly found in the home, and rock where iron, nickel, cobalt, and other ferromagnetic materials are present in relatively low concentrations. Magnetic communications may therefore be possible in various communication situations where substantial levels of attenuation otherwise prevent communication via radio frequency (RF) signals and/or other conventional mechanisms. For example, within buildings, underground, and/or other environments, signal reflection, absorption, and variations in the permittivity of materials in the propagation path can lead to signal attenuation and selective fading that can in turn increase the effective path loss and thereby prevent the possibility of communication. In contrast, for magnetic signals, the most relevant material property is permeability rather than permittivity (i.e., changes in relative permeability values may affect magnetic field levels). As such, magnetic fields have the ability to penetrate various materials that otherwise interfere with RF signals and thereby permit magnetic communication in various scenarios.

For example, one communication scenario in which magnetic communication may be advantageous is in applications that are related to the Internet of Medical Things (IoMT), which contemplates that people in a house may have one or more medical implants or medical devices that need to wirelessly transmit data to transponders located around the house. The transponders would then direct the appropriate data to a doctor, a hospital, or another suitable recipient via a mobile network. Furthermore, because the NULEF scheme described in further detail below may operate in a transceiver with a very low power dissipation, require a relatively small chip area, and communicate via magnetic fields that are substantially unaffected by the human body and other materials likely to be present in IoMT environments, the NULEF scheme may be well-suited to use in medical implants where small dissipation, small size, and interference are important considerations. Another potential communication scenario in which magnetic communication may be advantageous is where rescue workers may be searching for people who are lost underground after a mining accident, trapped beneath rubble after an earthquake, and so on. However, given that current NULEF implementations generally have a communication range limited to approximately 5 m or less, there exists a need to increase the range over which magnetic communications can be achieved, which may help to enable the IoMT and rescue use cases mentioned above and/or other use cases in which material permittivity and other factors may prevent communication.

According to various aspects, the following description sets forth an exemplary NULEF implementation in which one or more appropriate technologies may be applied to effectively extend the range associated with magnetic communications. More particularly, referring again to FIG. 2, the transceiver 40 shown therein includes a transmit antenna section 42 and a receive antenna section 44, which are each connected to a common antenna 46. As such, the transmit antenna section 42 is able to transmit signals via the antenna 46 and the receive antenna section 44 is able to receive signals via the antenna 46.

Referring still to FIG. 2, a modulator/demodulator (modem) unit 48 is connected to both the transmit antenna section 42 and the receive antenna section 44. The modem unit 48 may be configured to modulate data signals provided by a processing unit 50 to be transmitted by the transmit antenna section 42 onto a carrier signal provided by a signal generator 52. The modulator/demodulator unit 48 may also be configured to demodulate signals received by the receive antenna section 44, and to transmit the demodulated received signals to the processing unit 50. The processing unit 50 generates data signals to be modulated and transmitted, and processes received demodulated data signals. The processing unit 50 is also operative to control the quality factor and resonant frequency of the transmit antenna section 42, and to select an appropriate channel access scheme to increase a communication range between the transceiver 40 and a receiver in communication therewith, as described below.

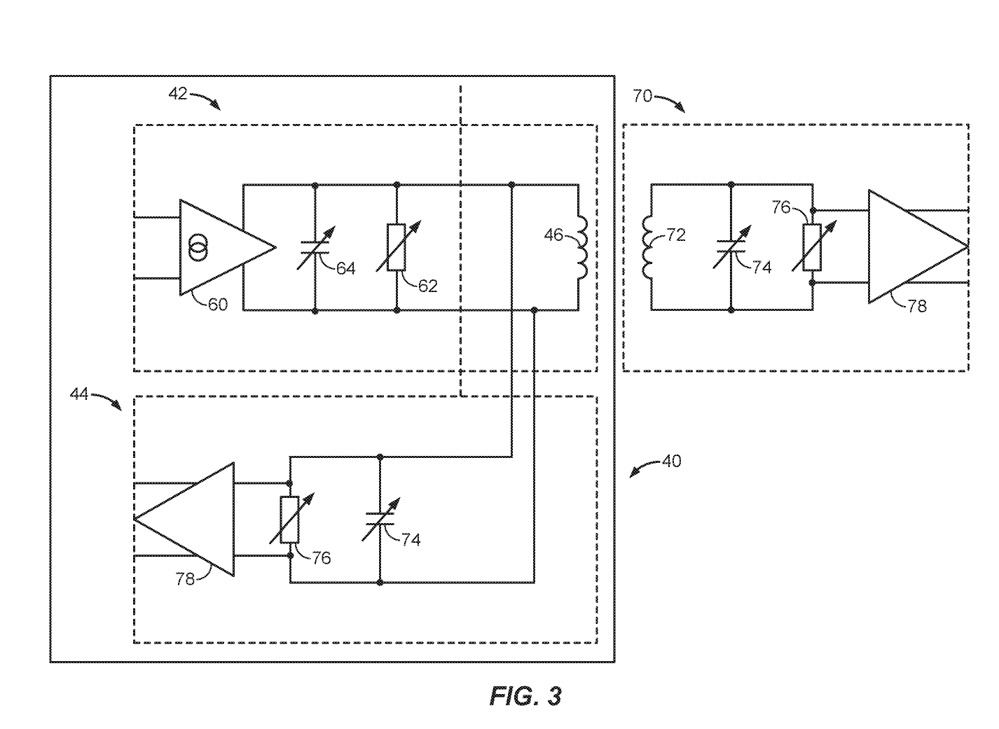

According to various aspects, referring now to FIG. 3, various components that may be present in a Near Ultra Low Energy Field (NULEF) transceiver are shown in more detail. In particular, FIG. 3 illustrates the transmit antenna section 42 of the transceiver 40 shown in FIG. 1 and a receive antenna section 70 of a remote transceiver, as well as the receive antenna section 44 of the transceiver 40. Again, those skilled in the art will appreciate that the schematic diagram shown in FIG. 3 only includes those components of the transmit antenna section 42 and the receive antenna section 44 that are necessary to understand the various aspects and embodiments described herein, and that a practical implementation of the transmit antenna section 42 and the receive antenna section 44 in a NULEF transceiver may include other components in addition to those shown in FIG. 3. Those skilled in the art will also appreciate that the same antenna matching structure is used in both the transmit antenna section 42 and the receive antenna section 44 of a NULEF transceiver 40.

According to various embodiments, the transmit antenna section 42 of the transceiver 40 comprises an amplifier 60 having differential current outputs, which are connected to input terminals of the antenna 46. A variable resistance 62 and a variable capacitance 64 connected to the outputs of the amplifier 60 in parallel with the antenna 46 form, with the self-inductance of the antenna 46, a parallel resonant network. In general, the amplifier 60 in the NULEF transceiver 40 may be referred to as a replenishing amplifier (RA) rather than the usual power amplifier, as no real power ideally needs to be transferred from transmit to receive components. Those skilled in the art will further appreciate that the variable resistance 62 need not be implemented as a physical variable resistor component, but may be implemented in any suitable way. For example, the resistance 62 may be generated parasitically in the amplifier 60 using a technique that allows the parasitically generated resistance to be adjusted to a desired value, or may be implemented using a bank of switchable fixed resistances, and/or implemented in other suitable ways.

The transmit antenna section 42 of the transceiver 40 communicates with a receive antenna section 70 of a NULEF receiver or another NULEF transceiver acting in a receive mode. For the sake of clarity, the receiving device will be referred to hereinafter as a receiver, but those skilled in the art will appreciate that this term encompasses a NULEF transceiver acting in a receive mode.

The receive antenna section 70 of the receiver (which, in the example illustrated in FIG. 3, is a transceiver of the type illustrated at 40 in FIG. 2) communicates with the transmit antenna section 42 of the transceiver 40 via the magnetically coupled coils (or antennas) of 46 and 72, with the other components of the receiver being in part represented by a variable capacitance 74 and a variable resistance 76 connected in parallel with the antenna 72 to form, with the self-impedance of the antenna 76, a resonant circuit. The receiver also includes a low noise amplifier (LNA) 78 having differential inputs that are connected in parallel with the antenna 72, the variable capacitance 74 and the variable resistance 76. Although differential connections that will better suit magnetic communications have been described herein, in some situations single-ended connections may be more advantageous. For example, a single-ended antenna can generate a significant E-field in addition to the magnetic field and communication range around and across the body may therefore benefit from having an E-field present in some situations. Again, those skilled in the art will understand that the variable resistance 76 need not be implemented as a physical variable resistor component, but may be implemented in any suitable way. For example the resistance 76 may be generated parasitically in the LNA 78 using a technique such as source degeneration that allows the parasitically generated resistance to be adjusted to a desired value, or may be implemented using a bank of switchable fixed resistances.

The receive antenna section 44 of the transceiver 40 is also shown in FIG. 3. In various embodiments, the receive antenna section 44 may be substantially identical in structure and function to the receive antenna section 70 of the remote transceiver described above, since the receiver in the example illustrated in FIG. 3 is a transceiver of the type described above and illustrated at 40 in FIG. 2. Accordingly, the components of the receive antenna section 44 shown in FIG. 3 are identified with the same reference signs used to identify the components of the receive antenna section 70 in FIG. 3.

The antenna 72 receives signals from the transmit antenna 46 by magnetic field induction, and these received signals are sensed by the LNA 78. Where a transceiver 40 incorporating the receive antenna section 44 is operating in receive mode, the amplifier 60 of the transmit antenna section 42 of the receiving transceiver 40 will normally be disabled (although in some instances the antenna 72 may be tuned by an active receiver while the amplifier 60 is operating), and may present some parasitic capacitance, which increases the effective capacitance represented in FIG. 3 by the variable capacitance 74. In general, the receiving transceiver must be able to maintain the center frequency of the resonant circuit formed by the combination of the inductance of the antenna 72 with the capacitance 74 and the resistance 76. As such, the capacitance 74 in the receiver is variable to permit adjustment to the center frequency of the resonant circuit of the receiver to compensate for parasitic capacitance from the disabled amplifier 60 and the like. To reject unwanted noise, the bandwidth of the receive antenna section 44 must also be controlled according to the received data rate. The resistance 76 is variable to permit this. The optimum noise figure for the LNA 78 will usually be achieved when the receive antenna 72 is tuned correctly.

The resonant frequency of the parallel resonant circuit formed from the variable resistance 62, the variable capacitance 64, and the self-inductance of the antenna 46 of the transmit antenna section 42 is determined at least in part by the value of the variable capacitance 64. Thus, by adjusting the capacitance value of the variable capacitance 64 the resonant frequency of the parallel resonant circuit of the transmit antenna section 42 can be tuned to the center frequency of a carrier signal used by the transceiver 40 to transmit data, to ensure optimum transmission of the signal to be transmitted.

Various factors may affect the performance of a system of the type illustrated in FIG. 3. For example, the Shannon-Hartley theorem on the capacity of a communication channel that is subject to noise, as in the case of a communication channel between the transmit antenna section 42 and the receive antenna section 44 of FIG. 3, states that the channel capacity C in bits per second is a function of the channel bandwidth B in Hertz, the received signal power S in Watts, and the received noise power N in Watts. In a NULEF system, the received noise level is almost solely determined by the noise generated by the resistance in the turns of the receiver antenna coil. Furthermore, the received signal power S in the communication channel of the NULEF system shown in FIG. 3 is inversely proportional to the cube of the physical distance D (i.e., 1/D³) or separation between the antenna 46 of the transmit antenna section 42 and the antenna 72 of the receive antenna section 44. For closely coupled antennas, the overall bandwidth of the path from transmitter to receiver is interactive. NULEF is intended to be a long range system so low coupled systems would be the normal operating mode. The load resistance of the receiving antenna 72 is made large (e.g., greater than 300 Ohms) to reduce the loading effect on the transmitter when the antennas are more closely coupled. However, in situations where the magnetic field strength is overly high such as in the vicinity of a wireless charger, a small fixed or switchable load resistance or some other non-linear device may need to be used for overvoltage protection. This also helps to reduce the interaction between the transmit antenna section 42 and the receive antenna section 44 in a NULEF transceiver 40 in more closely coupled situations.

The bandwidth B of the communication channel is inversely proportional to the loaded quality factor of the parallel resonant circuit of both the transmit antenna section 42 and the receive antenna section 44, while the loaded quality factor Q of either the transmit antenna section 42 or the receive antenna section 44 is dependent on the resistance value R in Ohms of the resistance 62, a resonant frequency F₀ in Hertz of the parallel resonant circuit, and a self-inductance value L of the antenna 46 in Henrys. The current in the antenna 46 is amplified by a factor that is dependent on the loaded quality factor Q of the parallel resonant circuit, wherein the current in Amps in the antenna 46 equals the current input to the parallel resonant circuit from the amplifier 60.

In general, the strength of a magnetic field generated around the antenna 46 is proportional to the current flow in the antenna 46. Thus, where the loaded quality factor Q is high, the strength of the magnetic field around the antenna 46 will also be high because the current in the antenna 46 is dependent on the loaded quality factor Q as indicated above. This is the important NULEF effect, where the current through the antenna 46 is the output current of the amplifier 60 multiplied by the loaded Q of the transmit antenna section 42. The magnetic field strength around the transmit antenna 46 is therefore increased by a factor of Q times above what would be possible for a series tuned circuit. The range of the NULEF is therefore increased. Alternatively for a fixed system range the output current of the amplifier 60 can be controlled or limited using the Q factor. As the power dissipation at the transmitter is determined by the current through the resistance 62, which is Q times less than through the antenna 46, the dissipation of energy (or power) can be very low and hence the system name NULEF.

According to various aspects, as mentioned above, NULEF is intended to be a long range system that offers the ability to engage in magnetic communication over a greater distance than other magnetic communication systems such as NFC. Nonetheless, the example NULEF implementation described above has a communication range from approximately 100 mm up to approximately 5 m for an antenna about the size of a credit card (PICC1) (72 mm×42 mm). As such, further improvements are needed to increase the range over which magnetic field induction can be used to communicate data between a transmitting antenna and a receiving antenna. For example, to be useful in an IoMT environment, the example NULEF implementation described above may need a range increase of about ten (10) times, meaning an extra signal gain of about 60 dB.

According to various aspects, one way to achieve the increased signal gain mentioned above may be to use code-division multiple access (CDMA), which refers to a channel access method typically used in various radio communication technologies (although here CDMA is applied to magnetic rather than radio communication). In general, CDMA is an example of a multiple access scheme, where several transmitters can send information simultaneously over a single communication channel, thereby allowing several users to share a band of frequencies without undue interference between the users. More particularly, CDMA employs spread-spectrum technology and a special coding scheme where each transmitter is assigned a spreading code used to spread a signal out over a wider bandwidth than would normally be required. Multiple users are thus able to use the same channel and gain access to the system without causing undue interference to each other. Those skilled in the art will appreciate that various details relating to techniques used in CDMA communication technologies are defined in publicly available standards and not repeated herein for brevity.

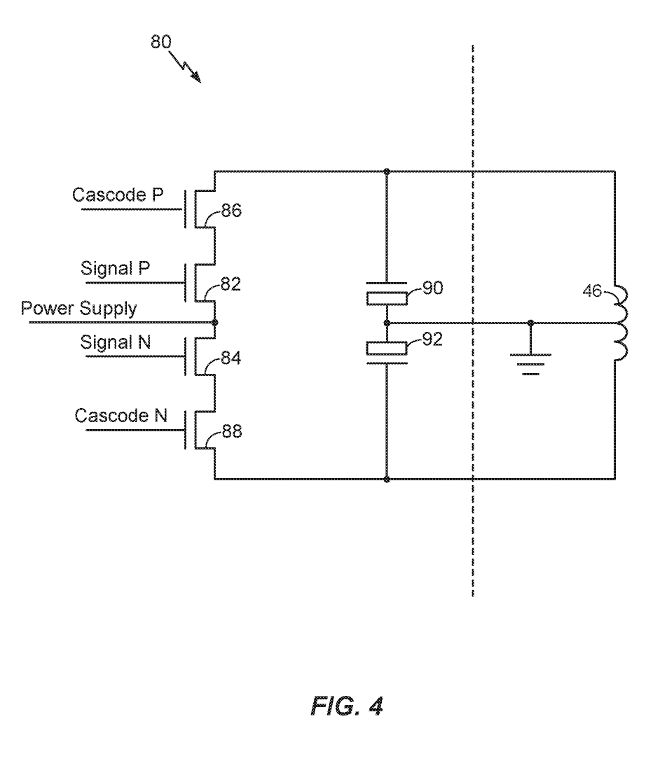

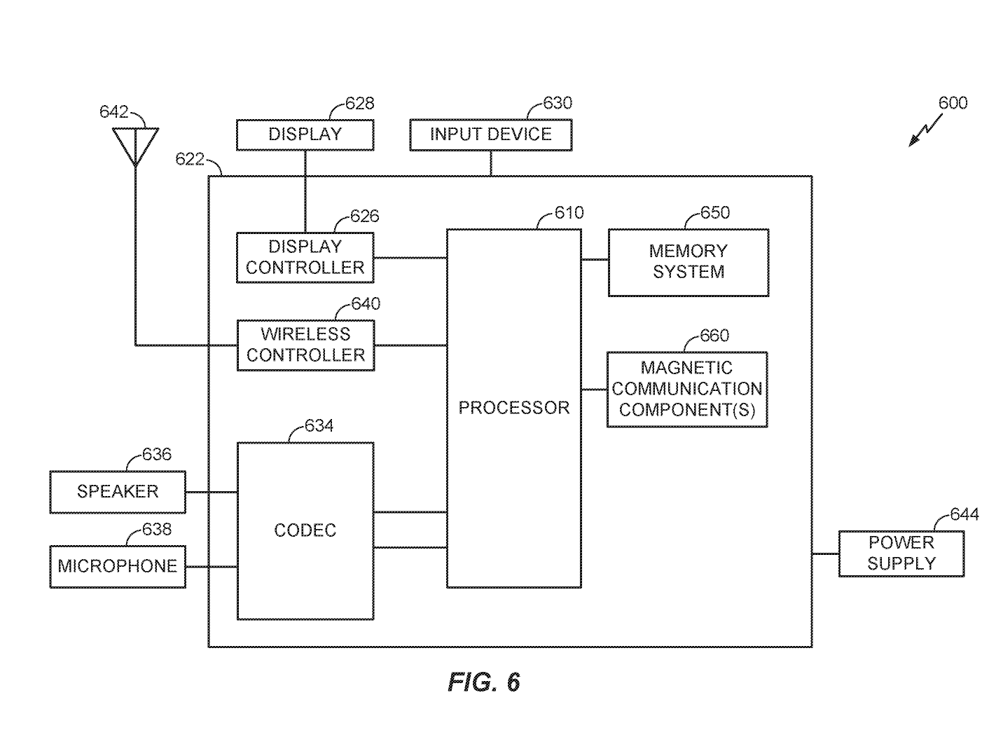

According to various aspects, as mentioned above, the use of spreading codes based on CDMA communication technologies may offer an increase in signal gain, which would result in an associated reduction in data rate of about one-thousand (1000) (e.g., from 2 Mbps to 2 kbps). In terms of data transfer from a medical implant device in an IoMT environment, this data rate should suffice to enable useful communication to transponders located within the IoMT environment. Furthermore, in addition to allowing useful data communication, data rates from about 2 kbps to 4 kbps would allow voice communication using a voice encoder (or vocoder). As such, a mobile handset (e.g., as shown in FIG. 6) may include a NULEF transceiver along with other suitable magnetic communication components such as NFC devices, a wireless charger, etc. Moreover, as will be described in further detail below with reference to FIG. 4, the NULEF chip area is quite small, which may allow a rake receiver and/or other suitable devices to be included to support the CDMA communication with minimal overhead. As such, the components needed to support NULEF-based and CDMA-based magnetic communication would provide the ability to engage in point-to-point communication in environments where materials along the transmission path would otherwise block conventional radio frequency (RF) or electromagnetic (EM) communications.

According to various aspects, another example where magnetic communications would operate where conventional RF or EM communications cannot would be underground or through rock or other materials with a relatively low concentration of ferromagnetic materials (e.g., iron, nickel, cobalt, etc.). A particular example of this would be to rescue workers following an earthquake, a mining accident, etc. If a rescue worker had a larger NULEF antenna, perhaps as large as an A4 sheet of paper (297 mm×210 mm), then the magnetic communications range could potentially be increased to between 50 m and 100 m when CDMA or other suitable spread-spectrum technologies are used. This would be a particularly useful tool as people trapped in a post-earthquake or other disaster situation are likely to be carrying a mobile phone. As such, the people needing to be rescued could potentially request help using a vocoder or perhaps simply switch on a location beacon. Different users would then use different TX spreading codes, thus allowing rescue workers to locate individuals independently.

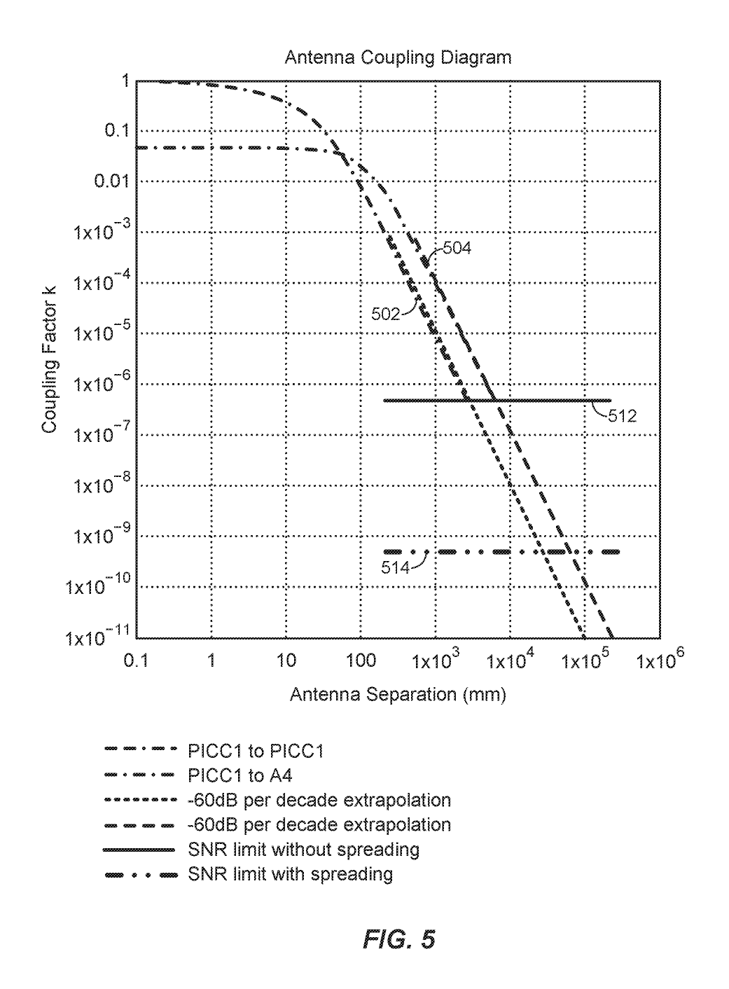

According to various aspects, the physics supporting the above-mentioned aspects are shown in FIG. 5, which illustrates an exemplary graph of antenna coupling versus distance for a magnetic transmitter and a magnetic receiver. In particular, the graph shown in FIG. 5 plots magnetic coil coupling (k) between a transmitting NULEF antenna and a receiving NULEF antenna as a function of the separation between the transmitting NULEF antenna and the receiving NULEF antenna. The plots in FIG. 5 relate to arrangements in which the transmitting NULEF antenna and the receiving NULEF antenna are flat, planar, rectangular structures located in parallel planes with centers lying on a common axis. Therefore, the “antenna separation” parameter assigned to the horizontal axis is the separation of the rectangular structures' centers along that common axis. Because the magnetic field around these antennas is toroidal in shape, and therefore not sharply directional, the curves would have similar shapes to those of FIG. 5 if measured off-axis up to an angular offset of about +/−45 degrees.

In FIG. 5, the plot 502 shows the variation in coupling between two credit card sized (PICC1) antennas and the plot 504 shows the variation in coupling between a PICC1 antenna and an A4-sized antenna. Furthermore, the line 512 shows the signal-to-noise ratio (SNR) limit without spreading and the line 514 shows the SNR limit with spreading (e.g., when CDMA is used to increase the signal gain). As such, for a wanted signal bandwidth of 1 MHz, there is an adequate level of SNR produced in a NULEF receiver for an ant coil coupling of 5*10⁻⁷ when the transmitting antenna produces a sufficiently high signal level, which could be achieved using a mobile phone. The coding gain due to spreading would increase the range by a factor of ten (10) times. As such, for communication between mobile phone antennas using the largish PICC1-sized antenna, the communication range could be up to 30 m, which is approximately where the plot 502 crosses below the line 514 depicting the SNR limit with spreading. If the antennas used were PICC1 to A4 size, then the range could be up to 70 m as shown where the plot 504 crosses below the line 514 depicting the SNR limit with spreading. On the other hand, the line 512 depicting the SNR limit without spreading shows that the useful range of the radios when spreading is not used is between 2 m to 7 m, whereby the use of spreading increases the useful range about tenfold. All these calculations assume the receiver has a reasonable noise figure performance of around 4 dB to 5 dB.

Turning now to FIG. 4, an exemplary circuit for implementing the transmit antenna section 42 of FIG. 3 is shown generally at 80. In the implementation illustrated in FIG. 4, p-type metal-oxide-semiconductor (PMOS) transistors 82, 84 constitute an amplifier (e.g., a replenishing amplifier) providing differential current outputs, which are connected to input terminals of the antenna 46 via variable transconductance (gm) cascodes 86, 88 connected to the differential outputs of the amplifier. As will be apparent to those skilled in the art, the circuit 80 illustrated in FIG. 4 could be rearranged so that a positive power supply was connected to the center tap of the antenna 46, in which case NMOS transistors would be used, and the PMOS transistors 82, 84 would be connected to ground rather than a positive power supply rail.

A digitally variable capacitor (CDAC) formed from switchable metal-oxide-semiconductor (MOS) capacitors represented as 90 and 92 is connected in parallel with the antenna 46 such that the antenna 46, the variable transconductance cascodes 86, 88, and the MOS capacitors 90, 92 form a parallel resonant circuit.

The variable transconductance cascodes 86, 88 permit the output impedance of the amplifier formed by the PMOS transistors 82, 84 to be adjusted, thereby permitting the loaded quality factor of the circuit 80 to be controlled. The CDAC formed by the MOS capacitors 90, 92 permits the resonant frequency of the parallel resonant circuit formed by the antenna 46, the variable transconductance cascodes 86, 88 and the MOS capacitors 90, 92 to be adjusted.

The PMOS transistors 82, 84, variable transconductance cascodes 86, 88 and MOS capacitors 90, 92 of the circuit 80 may be implemented as part of an integrated circuit (i.e. may be “on-chip” components), whilst the antenna 46 is an off-chip component (i.e. it is external to the integrated circuit containing the power amplifier 14). The circuit 80 therefore minimizes the number of off-chip components, which helps to reduce the bill of materials (BOM) cost of a NULEF transceiver 40 incorporating a transmit antenna section 42 and a receive antenna section 44 of the type illustrated in FIG. 3.

In the transmit antenna section 42 and the receive antenna section 44 described above and illustrated in FIG. 2 through FIG. 4, a variable capacitance 64 is provided to permit adjustment of the resonant frequency of the parallel resonant circuits of the transmit antenna section 42 and the receive antenna section 44. However, those skilled in the art will appreciate that the variable capacitance 64 could be replaced by an appropriate fixed capacitance, although in this case the resonant frequency of the parallel resonant circuit cannot be adjusted, and so if the resonant frequency of the parallel resonant circuit is not equal to the center frequency of the carrier frequency of the signal to be transmitted optimum transmission of the modulated carrier signal will not be possible.

In order to keep the received signal-to-noise ratio (SNR) high, the LNA 78 must have a good noise figure. The presence of any resistive loss in the receive antenna section 44 that includes any variable resistor for Q factor adjustment will generate unwanted thermal noise. Therefore, using physical variable resistors may be avoided in the receive antenna section 44. Instead, inductive or capacitive degeneration techniques can be employed in the LNA 78 to present the required resistance (the effective parallel resistance 76) to the antenna matching network in receive mode. The inductive or capacitive degeneration techniques used permit the effective parallel resistance 76 to be varied such that the loaded quality factor can be adjusted as described above, whilst obviating the thermal noise associated with a physical variable resistor.

According to various aspects, FIG. 6 illustrates an exemplary processing device 600 that may advantageously implement the various aspects described herein. In various embodiments, the processing device 600 may be configured as a wireless device. The processing device 600 can include or otherwise implement one or more aspects and/or embodiments discussed in further detail above, whereby the processing device 600 may at least include one or more magnetic communication components 660 that can be used to implement the magnetic communication system(s) and/or method(s) described above.

According to various embodiments, as shown in FIG. 6, the processing device 600 may include a processor 610, which can be a digital signal processor (DSP) or any general purpose processor or central processing unit (CPU) as known in the art, for example. The processor 610 may be communicatively coupled to a memory system 650, which may be configured to store instructions, data, and/or other suitable information associated with one or more applications that may execute on the processor 610 and implement the magnetic communication system(s) and/or method(s) described therein. According to various embodiments, FIG. 6 also shows that the processing device 600 may include a display controller 626 coupled to the processor 610 and to a display 628. The processing device 600 may further include a coder/decoder (CODEC) 634 (e.g., an audio and/or voice CODEC) coupled to processor 610. Other components, such as a wireless controller 640 (e.g., a modem) are also illustrated in FIG. 6. In various embodiments, a speaker 636 and a microphone 638 can be coupled to the CODEC 634. Furthermore, according to various embodiments, the wireless controller 640 can be coupled to a wireless antenna 642 as shown in FIG. 6.

According to various aspects, the processor 610, the display controller 626, the memory system 650, the CODEC 634, the wireless controller 640, and/or the magnetic communication components 660 may be included or otherwise provided in a system-in-package or a system-on-chip device 622. In various embodiments, an input device 630 and a power supply 644 may be coupled to the system-on-chip device 622. Moreover, as illustrated in FIG. 6, the display 628, the input device 630, the speaker 636, the microphone 638, the wireless antenna 642, and the power supply 644 are shown as being external to the system-on-chip device 622. However, those skilled in the art will appreciate that the display 628, the input device 630, the speaker 636, the microphone 638, the wireless antenna 642, and/or the power supply 644 can be coupled to a component associated with the system-on-chip device 622 (e.g., via an interface or a controller). Furthermore, although FIG. 6 depicts the processing device 600 as a wireless device, those skilled in the art will appreciate that the processor 610, the memory system 650, the magnetic communication components 660, etc. may also be integrated into a set top box, a music player, a video player, an entertainment unit, a navigation device, a personal digital assistant (PDA), a fixed location data unit, a computer, a laptop, a tablet, a communications device, a mobile phone, an electronic lock, an Internet of Things (IoT) device, or other similar devices.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A transceiver, comprising:
an antenna configured to transmit a signal via magnetic field induction;
a transmit section comprising:
an amplifier configured to drive the antenna;
a capacitance connected in parallel with the antenna; and
a resistance connected in parallel with the capacitance and the antenna, such that the antenna, the capacitance, and the resistance form a parallel resonant circuit, wherein a value of the resistance is variable to permit adjustment of a loaded quality factor of the parallel resonant circuit; and
a processing unit configured to generate the signal transmitted via the antenna and to use a spreading code to modulate the signal to be transmitted via the antenna.

2. The transceiver recited in claim 1, wherein the processing unit is configured to use code-division multiple access (CDMA) to modulate the signal.

3. The transceiver recited in claim 1, wherein the spreading code is assigned to the transceiver in accordance with a spread-spectrum multiple access scheme that permits multiple transmitters to simultaneously transmit information over a communication channel via the magnetic field induction.

4. The transceiver recited in claim 1, further comprising a rake receiver configured to decode a signal received at the antenna based on a spreading code used to modulate the received signal at a remote transmitter.

5. The transceiver recited in claim 1, wherein the antenna used to transmit the signal via the magnetic field induction is substantially symmetrical relative to a remote receiver configured to receive the signal via the magnetic field induction.

6. The transceiver recited in claim 1, configured to be used in in a Near Ultra Low Energy Field (NULEF) magnetic communication system.

7. The transceiver recited in claim 1, wherein the signal comprises a data signal.

8. The transceiver recited in claim 1, wherein the signal comprises a voice signal.

9. A method for magnetic communications, comprising:
generating, at a processing unit, a signal to be transmitted via magnetic field induction, wherein the processing unit is configured to use a spreading code to modulate the signal; and
transmitting the signal via an antenna configured to transmit the signal via the magnetic field induction, the antenna coupled to a transmit section comprising an amplifier configured to drive the antenna, a capacitance connected in parallel with the antenna, and a resistance connected in parallel with the capacitance and the antenna, such that the antenna, the capacitance, and the resistance form a parallel resonant circuit, wherein a value of the resistance is variable to permit adjustment of a loaded quality factor of the parallel resonant circuit.

10. The method recited in claim 9, wherein the processing unit is configured to use code-division multiple access (CDMA) to modulate the signal.

11. The method recited in claim 9, wherein the spreading code is determined in accordance with a spread-spectrum multiple access scheme that permits multiple transmitters to simultaneously transmit information over a communication channel via the magnetic field induction.

12. The method recited in claim 9, further comprising:
receiving a signal at the antenna; and
decoding, by a rake receiver, the signal received at the antenna based on a spreading code used to modulate the received signal at a remote transmitter.

13. The method recited in claim 9, wherein the antenna used to transmit the signal via the magnetic field induction is substantially symmetrical relative to a remote receiver configured to receive the signal via the magnetic field induction.

14. The method recited in claim 9, configured to be used in in a Near Ultra Low Energy Field (NULEF) magnetic communication system.

15. The method recited in claim 9, wherein the signal comprises a data signal.

16. The method recited in claim 9, wherein the signal comprises a voice signal.

17. An apparatus, comprising:
means for generating a signal to be transmitted via magnetic field induction;
means for modulating the signal using a spreading code; and
means for transmitting the signal via the magnetic field induction, wherein a capacitance is connected in parallel with the means for transmitting and a resistance is connected in parallel with the capacitance and the means for transmitting, such that the means for transmitting, the capacitance, and the resistance form a parallel resonant circuit, wherein a value of the resistance is variable to permit adjustment of a loaded quality factor of the parallel resonant circuit.

18. The apparatus recited in claim 17, wherein the means for modulating is configured to use code-division multiple access (CDMA) to modulate the signal.

19. The apparatus recited in claim 17, wherein the spreading code is determined in accordance with a spread-spectrum multiple access scheme that permits multiple transmitters to simultaneously transmit information over a communication channel via the magnetic field induction.

20. The apparatus recited in claim 17, further comprising:
means for receiving a signal transmitted via magnetic field induction; and
means for decoding the received signal based on a spreading code used to modulate the received signal at a remote transmitter.

21. The apparatus recited in claim 17, wherein the means for transmitting the signal via the magnetic field induction is substantially symmetrical relative to a remote receiver configured to receive the signal via the magnetic field induction.

22. The apparatus recited in claim 17, configured to be used in in a Near Ultra Low Energy Field (NULEF) magnetic communication system.

23. The apparatus recited in claim 17, wherein the signal comprises one or more of a data signal or a voice signal.

24. A computer-readable storage medium storing computer-executable instructions configured to cause a processing unit to:
generate a signal to be transmitted via magnetic field induction;
use a spreading code to modulate the signal; and
transmit the signal via an antenna configured to transmit the signal via the magnetic field induction, wherein a capacitance is connected in parallel with the antenna and a resistance is connected in parallel with the capacitance and the antenna, such that the antenna, the capacitance, and the resistance form a parallel resonant circuit, wherein a value of the resistance is variable to permit adjustment of a loaded quality factor of the parallel resonant circuit.

25. The computer-readable storage medium recited in claim 24, wherein the computer-executable instructions are configured to cause the processing unit to use code-division multiple access (CDMA) to modulate the signal.

26. The computer-readable storage medium recited in claim 24, wherein the spreading code is determined in accordance with a spread-spectrum multiple access scheme that permits multiple transmitters to simultaneously transmit information over a communication channel via the magnetic field induction.

27. The computer-readable storage medium recited in claim 24, wherein the computer-executable instructions are further configured to cause the processing unit to:
receive, via the antenna, a signal transmitted via magnetic field induction; and
decode, via a rake receiver, the received signal based on a spreading code used to modulate the received signal at a remote transmitter.

28. The computer-readable storage medium recited in claim 24, wherein the antenna used to transmit the signal via the magnetic field induction is substantially symmetrical relative to a remote receiver configured to receive the signal via the magnetic field induction.

29. The computer-readable storage medium recited in claim 24, configured to be used in in a Near Ultra Low Energy Field (NULEF) magnetic communication system.

30. The computer-readable storage medium recited in claim 24, wherein the signal comprises one or more of a data signal or a voice signal.
